(19) United States
(12) Patent Application Publication
(10) Pub. No.: US 2007/0064885 A1
(43) Pub. Date: Mar. 22, 2007

(54) System for delivering video on hard medium along with one or more items or vouchers to remote address

(76) Inventor: Kabir Ahuja, Little Silver, NJ (US)

Correspondence Address: Mr. Walter J. Tencza Jr., Suite 3, 10 Station Place, Metuchen, NJ, 08840, US

(21) Appl. No.: 11/221,660

(22) Filed: Sep. 8, 2005

(51) Int. Cl. H04M 11/00

(52) U.S. Cl. 379/88.13

(57) ABSTRACT

A video is captured at a local geographic location and stored in a computer memory. A gift is selected and an address is specified for an intended recipient at the local geographic location. Video and order information for the gift is sent out onto a communications network for delivery to a location remote from the local geographic location. The video and order information for the gift is received at the remote location. The video is converted into a converted video, the converted video is recorded onto a hard medium, and a physical gift is retrieved corresponding to the order information for the gift. The physical gift and the hard medium may be placed into a package, after the converted video has been recorded on the hard medium. The package may be sent to an intended recipient.

### FIELD OF THE INVENTION

This invention relates to improved methods and apparatus concerning providing videos.

### BACKGROUND OF THE INVENTION

There are known Internet online services available for item purchase and delivery. There are also video mail systems separately available.

### SUMMARY OF THE INVENTION

The present invention in one or more embodiments, includes a method comprising capturing a video at a local geographic location and storing the video in a computer memory. The method may also include selecting a gift at the local geographic location and specifying, at the local geographic location, an address for an intended recipient. The method may include sending the video and order information for the gift out onto a communications network for delivery to a location remote from the local geographic location.

The video may be comprised of any video, such as a still video or a motion picture video. The step of selecting the gift may be implemented using a computer. The step of specifying, at the local geographic location, an address for an intended recipient, may be implemented using a computer. The computer may include a computer monitor display. The computer may be programmed to display an image on the computer monitor display, the image including a plurality of fields showing a plurality of corresponding indications for a plurality of corresponding gifts.

The method may also include receiving, at the location remote from the local geographic location, the video and order information for the gift via the communications network. The method may also include converting the video into a converted video; recording the converted video onto a hard medium, and retrieving a physical gift corresponding to the order information for the gift. The physical gift and the hard medium may be placed into a package, after the converted video has been recorded on the hard medium. The package may be sent to an intended recipient. The order information may include a geographic address for the intended recipient.

The present invention, in one or more embodiments, may include an apparatus comprising a computer programmed by computer software, wherein the computer includes a computer memory. The computer may be programmed to capture a video at a local geographic location and store the video in the computer memory. The computer may be programmed to receive a selection of a gift at the local geographic location. The computer may be programmed to receive an address for an intended recipient at the local geographic location. The video and order information for the gift may be sent out onto a communications network for delivery to a location remote from the local geographic location.

An apparatus in accordance with one embodiment of the present invention, may also include a receiver computer programmed by computer software, a video conversion device, and a video recording device The receiver computer may be programmed to receive video and order information for a gift via a communications network. The receiver computer may be programmed to supply the video to the video conversion device. The video conversion device may convert the video into a converted video. The receiver computer may be programmed to record the converted video onto a hard medium. The apparatus may be further comprised of a label printer. The receiver computer may be programmed to cause the label printer to print out an address label for an intended recipient to receive the hard medium along with a physical gift corresponding to the order information for the gift.

One or more embodiments of the present invention, provide a communications service that can be implemented on top of a video communications system. The users of the video communications system can have videos recorded on a digital system locally. The videos can then be sent digitally, via the internet for example, or by e-mail to a remote processing center. The remote processing center can put the video onto a hard medium, such as a portable dedicated computer disk or any other hard medium. The remote processing center can also package the video on the hard medium with a product or with a voucher for a service. The video on the hard medium can then be shipped or otherwise delivered by a courier, such as by Fedex (trademarked) from the remote processing center to a remote physical address.

In at least one embodiment, users, either from a kiosk or from a home location, will be able to record a video message or use a prerecorded video to send to digitally to the remote processing center. The remote processing center could be anywhere in the world, from in the same state to a completely different country. The video can be sent digitally from a local server to the remote processing center through the Internet and/or through the use of proprietary software.

At the remote processing center, the video may be decoded and transferred to the hard medium. The hard medium may be any current or future mediums, such as for example without limitation video home system tape (“VHS”), video compact disk (“VCD”), and digital video disk (“DVD”). In at least one embodiment, the video on the hard medium can be delivered by a courier to a remote location, which can be specified. In addition to the video on the hard medium, the sender of the video may be given a catalogue of items to choose from to send along with the video, which may appear on the screen in catalogue form. These items can include any product or service available to consumers at a remote address of an intended recipient. This enables the sender to have added value when sending a video.

An example use of this system would be to send a video message for a birthday to a family member in a different country. A working professional in, for example the United States, might walk into their local cultural grocery store and see a kiosk with this video service. He or she would record a five minute message detailing their lives and giving good wishes. In addition, a gift of flowers and earrings would be selected. Then the physical address of the user's mother may be entered into the kiosk/user system. The system would digitally send this video to the remote processing center closest to the mother's physical address along with the gift request. The processing center would receive the video digitally and burn it to a digital video disk (“DVD”). The processing center would coordinate with a local warehouse and merchants to package the DVD along with the gifts requested for the mother and send it to the address by courier or mail service. If in close enough proximity, the option for a package pick-up could also be arranged. The mother would receive the package and would be able to view the message on a traditional DVD player. Alternatively, the video would be made available over a website if the recipient, in this case the mother, had a broadband connection.

### BRIEF DESCRIPTION OF THE DRAWINGS

FIG. 1a and FIG. 1b show a system and method for use in accordance with an embodiment of the present invention;

FIG. 2a and FIG. 2b show a sequence of computer monitor display screens for a method in accordance with an embodiment of the present invention; and

FIG. 3 shows a plurality of devices that may be used to implement the system and method of FIGS. 1a and 1b.

### DETAILED DESCRIPTION OF THE DRAWINGS

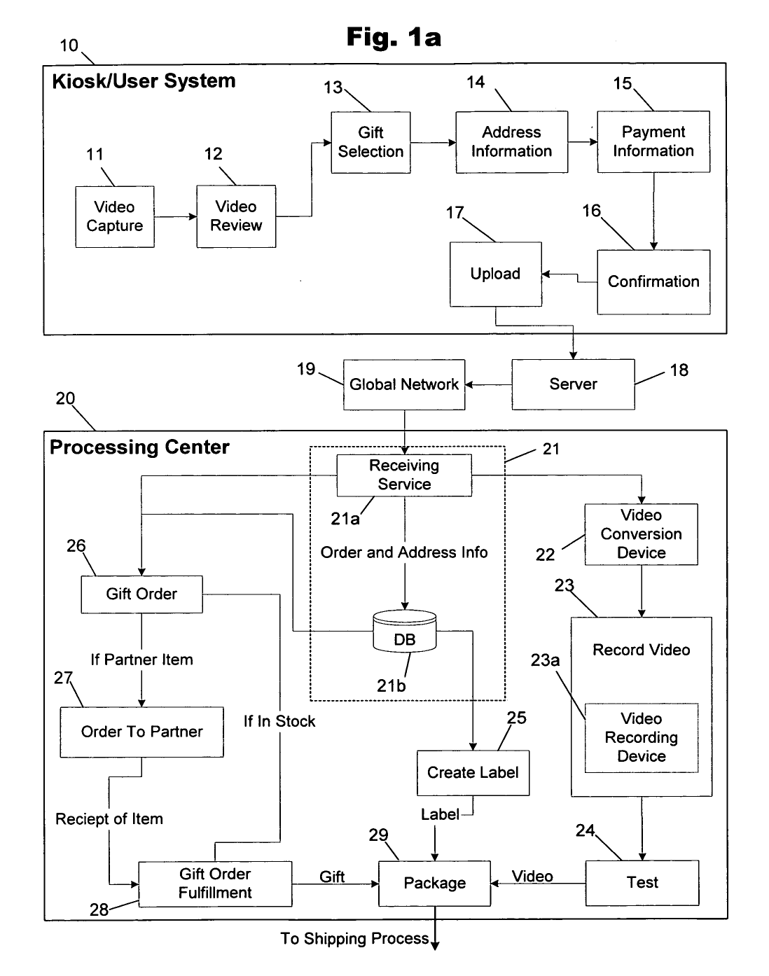

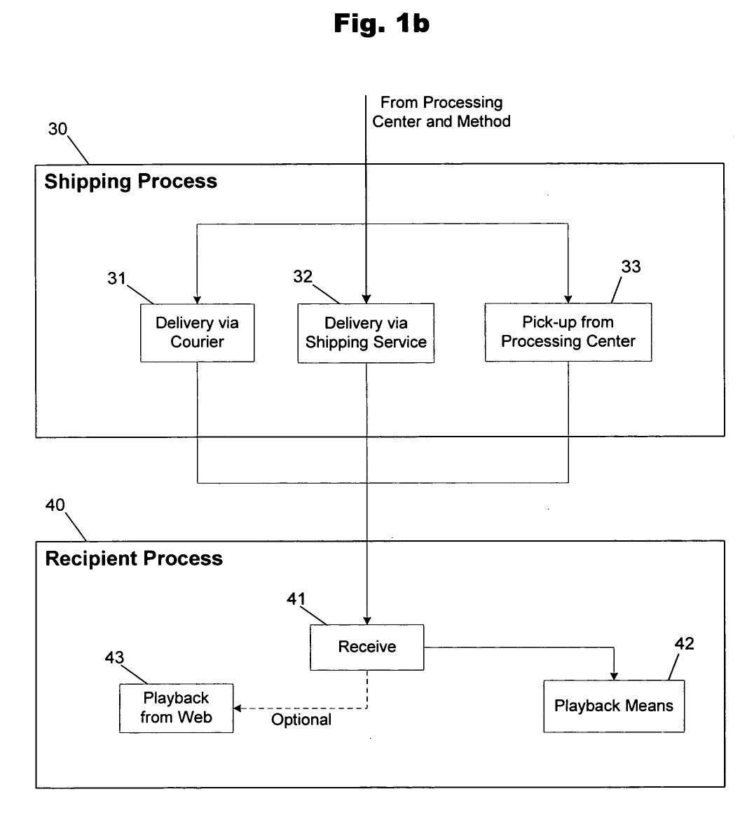

FIG. 1a and FIG. 1b show a system and method for use in accordance with an embodiment of the present invention. The system and method is comprised of a kiosk/user system 10, a server 18, a global network 19, a processing center and method 20, a shipping process 30 and a recipient process 40.

The kiosk/user system 10 includes method steps 11, 12, 13, 14, 15, 16, and 17. The kiosk/user system 10 is locally located and executed locally, i.e. typically in the same geographic location where a video is first captured at step 11.

The processing center and method 20 includes method steps 23, 24, 25, 26, 27, 28, and 29. The processing center and method 20 also includes a video conversion device 22 and a video recording device 23 such as a VCD, DVD, or VHS tape recorder. The processing center and method 20 may include a computer server 21, which includes runs computer software executing a receiving service 21a. The computer server 21 may also include a database (“DB”) 21b.

The video conversion device 22 may be implemented by computer software running on server computer 21. The video recording device 23 typically may also be implemented by computer software running on server computer 21. The video recording device may receive converted video from the video conversion device 22 and transfer the converted video to a hard media. The create label process 25 may be implemented by use of a label printer, controlled by computer software such as computer software running on server computer 21. The processing center and method 20 is typically remotely located and executed, i.e. located and executed in a different, remote geographic location from the consumer kiosk/user system 10.

The operation of one embodiment of the present invention can be divided into four parts. The first part is video capture locally at step 11 shown in FIG. 1a. The second part is processing by the remote processing center and method 20. The third part is delivery of a package including the converted video on a hard medium and any accompanying gift item. The fourth part is the receipt of the package and playback of the video by a recipient.

Video capture at step 11 in FIG. 1a, occurs either on any available user device or at a kiosk, such as kiosk/user system 10, built specifically for video capture. Examples of user devices, which can be used, for video capture for kiosk/user system 10 or instead of system 10 include a desktop computer, a laptop computer, a cellular phone, or a personal digital assistant (“PDA”). A video kiosk could also be used to implement kiosk/user system 10 or instead of kiosk/user system 10.

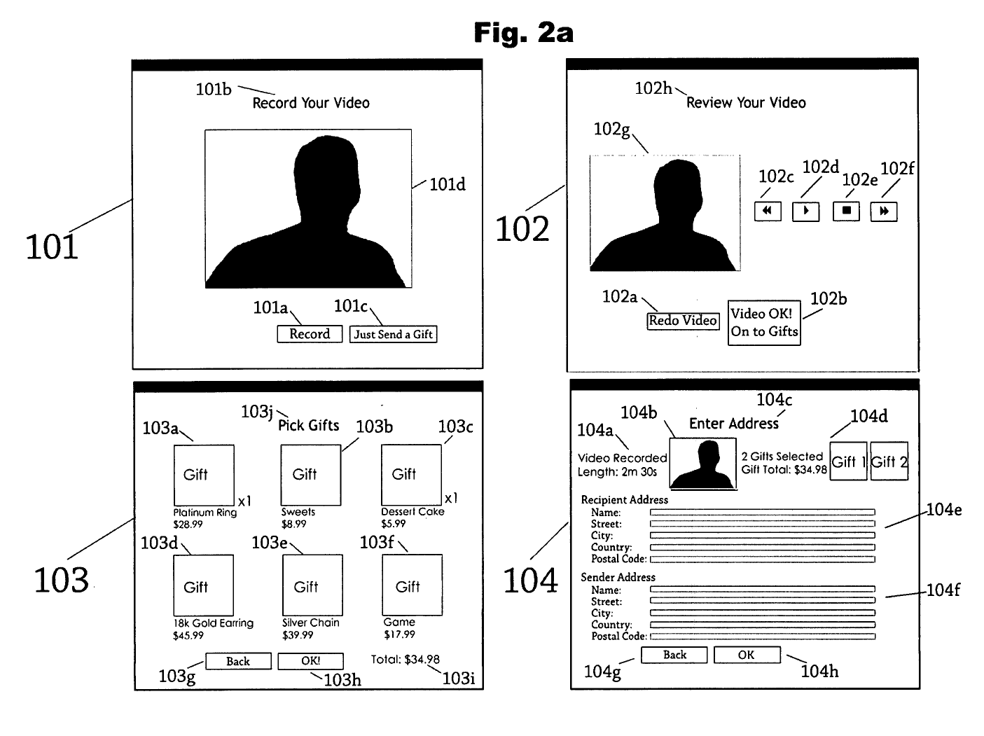

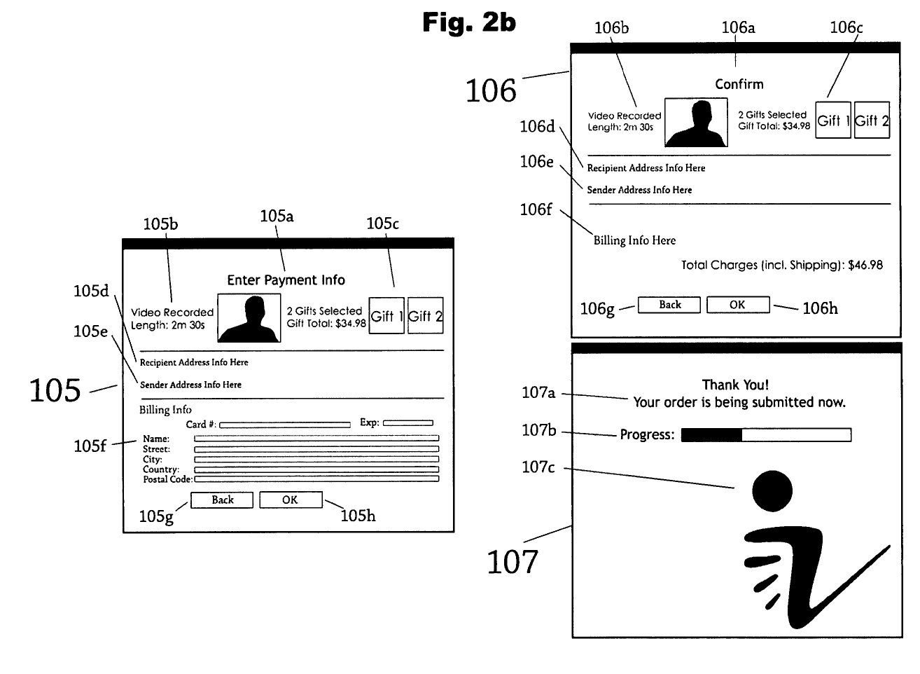

Regardless of the device used for the user device to execute system 10, the sequence of method steps 11-17 which correspond to method steps 101-107, respectively, in FIG. 2a and FIG. 2b, will dictate the steps the computer software running on the user device will complete in order to get a video message and order to the server computer 18. Alternatively, software could be designed for the user device for kiosk/user system 10 to allow a previously recorded video to be sent. This would change the video capture step 11 to a select file step. For either method, the computer software could be independent or web browser-based (run through a web browser, such as for example Internet Explorer (trademarked)).

The system 10 can be used to capture a video signal or signals at step 11 and may store the video signal or signals or data relating to them in computer memory, within the user device for kiosk/user system 10. The videos or video signals can be encoded in any current or future video codec (Hardware or software that reduces file size through compression). An example is MPEG-4 (codec defined by Moving Pictures Expert Group).

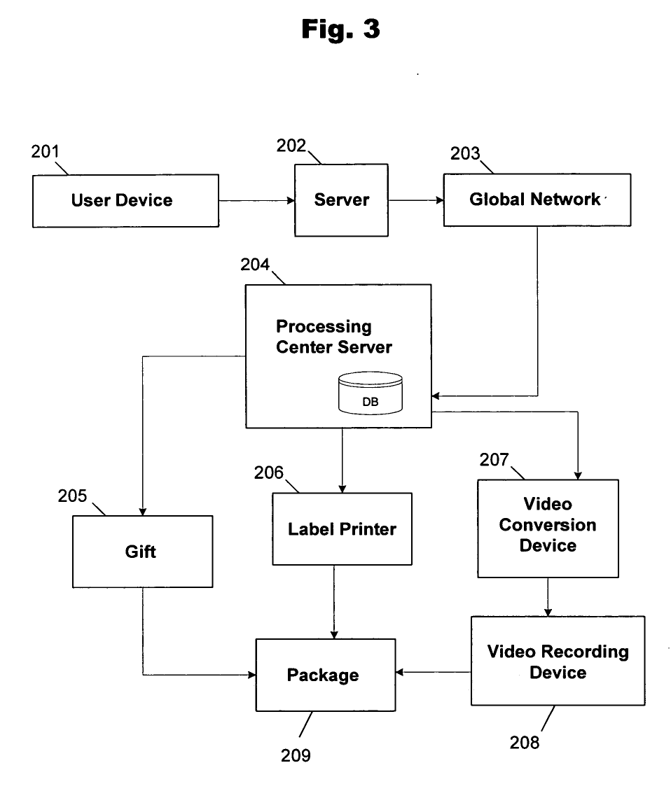

After reviewing the video on the user device (such as user device 201 of FIG. 3) at optional step 12 shown in FIG. 1a, the user can select any items that would be sent along with the video at step 13 by using the user device, such as user device 201. For example, if the user device is a personal computer, the user can select via a computer mouse from a display monitor screen or image on a display monitor, the items to be sent along with the video as shown in screen 103 of FIG. 2b. Examples of items include clothing items, chocolates, flowers, toys, and even vouchers or credits for services (house cleaning, car fixing, etc.). Any orderable item or service could be included. A physical address (such as “10 Elm Street, Small Town, U.S.A. 55555”) to send the video on the hard media and items to must be specified at step 14, again by entry of the address into the user device, such as a user personal computer via a computer mouse and keyboard. Payment details would be entered next at step 15, followed by a confirmation of all choices at step 16, again by entries into the user device, such as user device 201. Once the information is confirmed, the order request would be sent to the server computer 18 shown in FIG. 1a.

The server computer 18 receives the request from the kiosk/user system 10 and determines the closest processing center, such as the processing center for processing center and method 20, and relays the video and request to the processing center of processing center and method 20 through the global network 19, such as through the internet. A network of processing centers can be set up all around the world to handle video and item delivery. The server computer 18 can access a list of the processing centers and can determine the closest processing center to the particular geographic address location of an intended remote recipient.

The receiving service 21a of the processing center and method 20 can be anything used to parse the information received from global network 19 and start the appropriate processes within the processing center and method 20. The receiving service 21a could be implemented entirely by a computer running computer software, with the computer software sending out the item order, starting the video conversion, and printing a label. If the receiving service 21a is computer software driven, it would reside on a processing center computer server 21. Another alternative for receiving service 21a is a person checking supply for the item(s) requested, e-mailing the video to another employee for conversion, and writing out the label by hand.

Once the video, in digital form, is received by the receiving service 21a at the location for the remote processing center and method 20 it is converted into an appropriate format by video conversion device 22. The converted video is then copied onto a hard medium through either an automated process or a human operator using video recording device 23. Video recording device 23 may be a VCR or DVD-Recorder, or any other video recording device. The hard medium may be any current or future medium, such as for example but without limitation VHS tape, VCD, and DVD (Video Home System Tape, Video Compact Disk, Digital Video Disk). The hard medium, including the video, may then be tested at optional step 24.

The receiving service 21a will also place information received from the global network 18 into the database 21b, which may reside on computer processing center server 21. This information typically includes gift order information, recipient and sender geographical addresses, and payment information. The receiving service 21a will typically start the gift order as well at step 26. If the items that are part of the order are not available in the processing center stock, an order can be sent at step 27 so the item can be delivered to the location of the processing center and method 20. The order will be considered fulfilled once the all items associated with the order are at the location of the processing center and method 20.

When order information is added to the database 21b, the intended recipient information will be used to print a label at step 25. This can be an automated process or a person can do this manually. Once all elements of the order are assembled (video and gifts), they typically will be placed in a package, such as a box or envelope. An address label for the intended recipient will be affixed to the package and the package or parcel will be ready for shipping following step 29.

Delivery can occur through three channels. The first is via courier at step 31 shown in FIG. 1b. In this method, most likely used in major cities, the package will be delivered by a person who will likely pick up the package from the location of the processing center and method 20. An alternative method of delivery is via standard shipping channels 32 shown in FIG. 1b. Finally, the intended recipient may choose to pick up the package at the location of the processing center and method 20 at step 33.

Once the package is received at step 41 shown in FIG. 1b, the recipient will have possession of the video and accompanying gift items. The video can be played back in the appropriate media player 42. The video can also be viewed on the internet 43.

FIG. 2a and FIG. 2b show a sequence of computer monitor display screens or images for a method in accordance with an embodiment of the present invention. FIG. 2a shows monitor display screens or images 101-104 and FIG. 2b shows monitor display screens or images 105-107. The screens or images 101-107 may be located on a computer monitor display screen for a user device, such as user device 201 of FIG. 3.

FIG. 3 shows a block diagram of various hardware components that may be used for an embodiment of the present invention. FIG. 3 shows a user device 201, computer server 202, global network 203, processing center server 204, a gift 205, label printer 206, video conversion device 207, video recording device 208 and package 209. The computer server 202, global network 203, processing center server 204, video conversion device 207, and video recording device 208 may be the same as components 18, 19, 21, 22, and 23 shown in FIG. 1a.

At step 11 of FIG. 1a, image or screen 101, shown in FIG. 2a, appears on a computer monitor display screen for the user device 201. The image 101 has fields 101a, 101b, 101c, and 101d. The field 101a can be clicked on to record a video onto computer memory in the user device 201. The video may be comprised of a still video or a motion picture video or any other video. The field 101c can be clicked on to only order a gift to be sent to an intended recipient without an accompanying video. The field 101d displays the video as it is being recorded. The field 101b displays an indication or statement that the video is being recorded.

At step 12 of FIG. 1a, image or screen 102 shown in FIG. 2a appears on the user device 201. The image 102 has fields 102a, 102b, 102c, 102d, 102e, 102f, 102g, and 102h. The field 102a can be clicked on to redo the recording of a video, and would cause the user device 201 to execute step 11 again and display image 101 on the computer monitor display of the user device 201. The field 102b can be clicked on to confirm that the video which has been recorded is “OK”, and this would cause the image 103 to be next displayed on the computer monitor display of the user device 201. The field 102g shows the video, which has been recorded. The field 102c, when clicked on, causes the video shown in field 102g to rewind. The field 102d, when clicked on causes the video shown in field 102g to play. The field 102e, when clicked on causes the video shown in field 102g to stop. The field 102f, when clicked on causes the video shown in field 102g to fast forward. Field 102h provides an indication or statement that the video recorded on user device 201 is being reviewed.

At step 13 of FIG. 1a, image or screen 103, shown in FIG. 2a, is displayed on a computer monitor display for the user device 201. The image or screen 103 includes fields 103a, 103b, 103c, 103d, 103e, 103f, 103g, 103h, 103i, and 103j. Each of fields 103a-103f provides an image of a potential gift to be sent with or without a video. Each of fields 103a-103f also provides an item description and a price beneath the image of the potential gift. The number of gifts displayed on screen 103 is merely an example; the number of gifts offered is not limited by either number of gifts and there is no requirement for a concurrent display. Field 103g, when clicked on, would return a user to the previous screen or image 102, i.e. cause the previous screen or image 102 to be displayed on the computer monitor display of the user device 201. Field 103h, when clicked on, causes a gift to be accepted for sending and causes the image 104 to be next displayed on the computer monitor display of the user device 201. Field 103i shows the total amount of the cost of gifts selected. Field 103j shows a statement indicating “Pick Gifts”.

At step 14 of FIG. 1a, image or screen 104 is displayed on the computer display monitor for the user device 201. The image or screen 104 includes fields 104a, 104b, 104c, 104d, 104e, 104f, 104g, and 104h. The field 104a indicates the length of the video recording to be sent. The field 104b shows the video. The field 104c shows a statement indicating “Enter Address”. The field 104d shows information and images regarding two gifts, which have been selected to be sent along with the video. The field 104e includes entry boxes for entering address information for a recipient. The information may be entered through a computer keyboard, which may be part of the user device 201. The field 104f includes entry boxes for entering address information for a sender. The information may be entered through a computer keyboard, which may be part of the user device 201. The field 104g, when clicked on, returns a user to the previous screen 103. The field 104h, when clicked on, causes the address information of image 104 to be entered into the computer memory of the user device 201 and causes the image 105 to be next displayed on the computer monitor display or screen of user device 201.

At step 15 of FIG. 1a, image or screen 105, shown in FIG. 2b, is displayed on the computer display monitor for the user device 201. The image or screen 105 includes fields 105a, 105b, 105c, 105d, 105e, 105f, 105g, and 105h. Field 105a shows a statement indicating “Enter Payment Info”. Field 105b indicates the video recording time length. Field 105c shows information regarding the gifts selected. Field 105d shows the recipient address information entered in 104e of image or screen 104 shown in FIG. 2a. Field 105e shows the sender address information entered in 104f of image or screen 104. Field 105f includes boxes for entering billing address, credit card number, and expiration date. Field 105g for “Back” returns a user to the previous screen 104. Field 105h for “OK” causes the payment information of image 105 to be entered into the computer memory of the user device 201 and causes the image 106 to be next displayed on the computer display monitor or screen of the user device 201

At step 16 of FIG. 1a, image or screen 106, shown in FIG. 2b, is displayed on the computer monitor display or screen for the user device 201. The image or screen 106 includes fields 106a, 106b, 106c, 106d, 106e, 106f, 106g, and 106h. Field 106a shows a statement indicating “Confirm”. Field 106b indicates the video recording time length. Field 106c shows information regarding the gifts selected. Field 106d shows the recipient address information entered in field 104e of FIG. 2a. Field 106e shows the sender address information entered in field 104f of FIG. 2a. Field 106f includes Total charges and the billing information entered in field 105f. Field 106g for “Back”” returns a user to the previous screen 105. Field 106h for “OK” confirms all gift choices and information entered, causes the image 107 to be next displayed on the computer monitor display or screen of user device 201, and advances to step 17 of FIG. 1a.

At step 17 of FIG. 1a, image or screen 107 is displayed on the computer monitor display for the user device 201. The image or screen 107 includes fields 107a, 107b, and 107c. Field 107a states that the order is being submitted. Field 107b shows the progress of the order. The progress bar represents the percentage of the video file that has been transferred to the server computer 21 of the processing center and method 20 shown in FIG. 1a. Field 107c is the logo of the service for branding purposes.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising the steps of:
capturing a video at a local geographic location and storing the video in a computer memory;
selecting a gift at the local geographic location;
specifying, at the local geographic location, an address for an intended recipient; and
sending the video and order information for the gift out onto a communications network for delivery to a location remote from the local geographic location.

2. The method of claim 1 wherein
the video is comprised of a motion picture video.

3. The method of claim 1 wherein
the step of selecting the gift is implemented using a computer.

4. The method of claim 1 wherein
the step of specifying, at the local geographic location, an address for an intended recipient, is implemented using a computer.

5. The method of claim 3 wherein
the computer includes a computer monitor display;
wherein the computer is programmed to display an image on the computer monitor display, the image including a plurality of fields showing a plurality of corresponding indications for a plurality of corresponding gifts.

6. The method of claim 1 further comprising
receiving, at the location remote from the local geographic location, the video and order information for the gift via the communications network;
converting the video into a converted video;
recording the converted video onto a hard medium;
retrieving a physical gift corresponding to the order information for the gift;
placing the physical gift and the hard medium into a package, after the converted video has been recorded on the hard medium; and
sending the package to an intended recipient;
wherein the order information includes a geographic address for the intended recipient.

7. A method comprising the steps of
receiving a video and order information for a gift via a communications network;
converting the video into a converted video;
recording the converted video onto a hard medium;
retrieving a physical gift corresponding to the order information for the gift;
placing the physical gift and the hard medium into a package, after the converted video has been recorded on the hard medium; and
sending the package to an intended recipient;
wherein the order information includes a geographic address for the intended recipient.

8. An apparatus comprising
a computer programmed by computer software;
wherein the computer includes a computer memory;
wherein the computer is programmed to capture a video at a local geographic location and store the video in the computer memory;
wherein the computer is programmed to receive a selection of a gift at the local geographic location;
wherein the computer is programmed to receive an address for an intended recipient at the local geographic location;
and wherein the computer is programmed to send the video and order information for the gift out onto a communications network for delivery to a location remote from the local geographic location.

9. An apparatus comprising
a receiver computer programmed by computer software;
a video conversion device; and
a video recording device;
wherein the receiver computer is programmed to receive video and order information for a gift via a communications network;
wherein the receiver computer is programmed to supply the video to the video conversion device;
wherein the video conversion device converts the video into a converted video; and
wherein the receiver computer is programmed to record the converted video onto a hard medium.

10. The apparatus of claim 9 further comprising
a label printer; and
wherein the receiver computer is programmed to cause the label printer to print out an address label for an intended recipient to receive the hard medium along with a physical gift corresponding to the order information for the gift.

11. The apparatus of claim 8 further comprising
a receiver computer programmed by computer software;
a video conversion device; and
a video recording device;
wherein the receiver computer is programmed to receive the video and order information for the gift via the communications network;
wherein the receiver computer is programmed to supply the video to the video conversion device;
wherein the video conversion device converts the video into a converted video; and
wherein the receiver computer is programmed to record the converted video onto a hard medium.

12. The apparatus of claim 11 further comprising
a label printer; and
wherein the receiver computer is programmed to cause the label printer to print out an address label for an intended recipient to receive the hard medium along with a physical gift corresponding to the order information for the gift.
